(19) United States
(12) Patent Application Publication
(10) Pub. No.: US 2004/0096598 A1
(43) Pub. Date: May 20, 2004

(54) Ink-jet recording medium and method for production thereof

(75) Inventors: Kunio Kasamatsu, Tokyo (JP); Hiroaki Inoue, Tokyo (JP); Norimasa Miyachi, Tokyo (JP); Shuzo Kinoshita, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Mitsubishi Paper Mill Limited, Tokyo (JP)

(21) Appl. No.: 10/380,634

(22) PCT Filed: Oct. 15, 2001
(86) PCT No.: PCT/JP01/09039

(30) Foreign Application Priority Data
Oct. 16, 2000 (JP) 2000-314906
Oct. 16, 2000 (JP) 2000-314907
Dec. 19, 2000 (JP) 2000-384764
Dec. 19, 2000 (JP) 2000-384765

(51) Int. Cl. B41J 2/01

(52) U.S. Cl. 428/32.1

(57) ABSTRACT

The object of the present invention is to provide an ink jet recording medium which is high in gloss and ink absorption and excellent in image colorfulness and adhesion of the coats and a method for producing the same. According to the present invention, there is provided an ink jet recording medium which comprises a support, an undercoat layer containing a salt of an alkaline earth metal and an adhesive provided on the support and an ink-receiving layer provided by coating a coating solution containing inorganic ultrafine particles on the undercoat layer. The undercoat layer preferably contains the adhesive in an amount of 0.05-0.8 time the amount of the salt of alkaline earth metal in weight ratio. Furthermore, the undercoat layer preferably contains an organic pigment. The alkaline earth metal is preferably calcium or magnesium, and more preferably the salt of the alkaline earth metal is a carbonate. The inorganic ultrafine particles are of an amorphous synthetic silica produced by a gas phase method or an alumina compound. There is further provided a method for producing the ink jet recording medium according to which the ink-receiving layer is provided after the undercoat layer is coated and subjected to a hot calendering treatment.

### TECHNICAL FIELD

The present invention relates to an ink jet recording medium and a method for producing the same, and more particularly, it relates to an ink jet recording medium which comprises a support, an undercoat layer provided on the support, and an ink-receiving layer provided on the undercoat layer by coating a coating solution for the ink receiving layer containing inorganic ultrafine particles. This ink jet recording medium is superior in adhesion of the coat layers, high in gloss, high in ink absorption, excellent in colorfulness of images and high in smoothness.

### BACKGROUND ART

Ink jet recording systems perform recording of images or letters by ejecting ink droplets according to various operational principles and depositing them on recording media such as paper. The recording systems have the features that they carry out the operation at high speed, produce little noise, can easily perform multicolor printing, are great in versatility of patterns to be recorded, and require no development-fixation, and the systems recently rapidly spread as recording apparatuses in various uses for recording various figures and color images including Chinese characters. Furthermore, the images obtained by multicolor ink jetting systems are not inferior in quality to the recorded images obtained by the multicolor printing according to plate making systems or the color photographic systems. Moreover, when a small number of prints are to be produced, they can produce the prints more cheaply than the photographic techniques. Thus, ink jet recording systems are being widely applied to the field of full-color image recording.

Moreover, with diversification of uses, use of them for preparation of large-sized posters and POP arts and for drafting has increased. In these uses, satisfactory images can be obtained due to utilization of high sharpness and excellent color attainable by ink jet recording, resulting in a high propaganda effect. Application to these uses increases because images excellent in image reproducibility or color reproducibility such as sharpness and colorfulness can be easily obtained on personal computer level, and this is a reason for making much use of ink jet recording media.

Owing to enhancement of performance and diversification in use of the ink jet recording apparatuses, characteristics demanded for ink jet recording media are also considerably enhanced. Especially, recording apparatuses advertised to be able to produce images of high minuteness and those which can produce prints of large size require considerably larger amount of ink for the formation of images than conventional apparatuses, and improvement of ink-receiving layer for absorbing ink is being advanced.

Furthermore, diversification of uses affects the external appearance of ink jet recording media, and in addition to the external appearance of no or low gloss such as of conventional plain paper or matte paper, appearance having such gloss as of art paper, coated paper, cast paper and photographic paper is demanded. This is because of the demand for the ink jet recording to reproduce image quality corresponding to that of prints and photographs, and, besides, appearance resembling that of prints and photographs.

As ink jet recording media having gloss surface, JP-A-6-320857 discloses a cast-coated paper obtained by subjecting to cast-finishing during the coat being in wetted state. However, the surface gloss is much lower than that of silver salt photographic papers, and the texture of silver salt photographs cannot be obtained.

As ink jet recording media having enhanced surface gloss, there have been proposed those which comprise a support and an ink-receiving layer comprising a resin provided on the support. As examples of the resins used for this purpose, various ink absorbing polymers have been proposed, such as polyvinyl pyrrolidone and vinyl pyrrolidone-vinyl acetate copolymer as disclosed in JP-A-57-38185 and JP-A-62-184879, resin compositions mainly composed of polyvinyl alcohol as disclosed in JP-A-60-168651, JP-A-60-171143 and JP-A-61-134290, copolymers of vinyl alcohol, olefin or styrene and maleic anhydride as disclosed in JP-A-60-234879, polyethylene oxide crosslinked with isocyanates as disclosed in JP-A-61-74879, mixtures of carboxymethyl cellulose and polyethylene oxide as disclosed in JP-A-61-181679, polymers obtained by grafting methacrylamide on polyvinyl alcohol as disclosed in JP-A-61-132377, acrylic polymers having carboxyl groups as disclosed in JP-A-62-220383, polyvinyl acetal polymers as disclosed in JP-A-4-214382, and crosslinkable acrylic polymers as disclosed in JP-A-4-282282 and JP-A-4-285650. Furthermore, JP-A-4-282282 and JP-A-4-285650 propose ink jet recording media comprising a polymer matrix composed of a crosslinkable polymer and an ink absorbing polymer in combination. However, although ink-receiving layers comprising these resins have a surface gloss, they have defects that they are lower in absorbing speed and less in absorbing amount as compared with ink-receiving layers comprising pigment fine particles such as silica.

As ink jet recording media high in ink absorbing speed and increased in surface gloss, ink jet recording media using alumina hydrates (cationic alumina hydrates) have recently been proposed, and, for example, JP-A-60-232990, JP-A-60-245588, JP-B-3-24906, JP-A-6-199035 and JP-A-7-82694 disclose ink jet recording media comprising a support on which fine pseudoboehmite type alumina hydrate is coated together with a water-soluble adhesive. However, although ink jet recording media using fine pseudoboehmite type alumina hydrate have very high surface gloss, they are small in pore volume, and, hence, as disclosed in JP-A-5-24335, they are less in ink absorption capacity, and a thick coating is necessary to obtain a sufficient ink absorption capacity.

Moreover, JP-A-10-203006 and JP-A-8-174992 propose ink jet recording media which use synthetic silica having a primary particle diameter of 3-30 nm and prepared mainly by a gas phase method. In this case, also a coat thickness of 30 μm or more is necessary to obtain a sufficient absorption capacity. Moreover, JP-A-11-48602 discloses ink jet recording media which have a first ink absorption layer containing a hydrophilic adhesive and solid fine particles in an amount of 0.5-2.5 times that of the hydrophilic adhesive in weight ratio and a void layer having a dry film thickness of 5-30 μm and containing fine particles of not more than 100 nm in average particle diameter. However, in this case, the void layer must be thick in order to obtain a sufficient ink absorption, and if the layer is made thicker, defects such as cracking occur and for balancing the thickness and the ink absorption, amount of the adhesive in the first ink absorbing layer must be larger, but this first ink absorption layer does not contributes to improvement of the ink absorption.

On the other hand, there is a proposal to obtain sharpness of images by cogitating a base paper on which an ink-receiving layer is to be provided. For example, JP-A-62-162588 discloses ink jet recording media of not less than 90% in sheet whiteness which comprise a bleached pulp of not less than 90% in whiteness and a loading material having absorption properties. However, according to this method, sufficient whiteness and absorption can be obtained, but there cannot be obtained glossy images having high-grade quality. Further, JP-A-11-129613 discloses recording papers which are provided with a layer containing solid fine particles having a fluorescent brightening effect. However, this method requires a step of providing the layer containing a specific component or a step of adding a specific component to the ink-receiving layer, which causes complication of the production method and is not preferred.

Furthermore, JP-A-4-204727 and JP-A-4-296745 disclose resin-coated supports for photography which are improved in whiteness. However, these technologies aim at production of photographic papers, and since the papers are coated with a resin, ink absorption capacity is small, and in order to obtain a sufficient ink absorption capacity, the ink-receiving layer must be thick. JP-A-2000-33771 discloses ink jet recording media comprising a base paper which has on one side a layer containing barium sulfate and a thermoplastic hollow fine beads and is coated with an ink-receiving layer comprising polyvinyl alcohol, polyvinyl pyrrolidone and a vinyl acetate-butyl acrylate copolymer. However, since the ink-receiving layer comprises resins, it has a surface gloss, but is lower in absorption speed and less in absorption amount as compared with an ink-receiving layer comprising fine particles of pigment such as silica.

### DISCLOSURE OF INVENTION

The object of the present invention is to provide an ink jet recording medium which has high gloss and ink absorption, excellent colorfulness and has no problem in adhesion of the ink-receiving layer, and a method for producing the ink jet recording medium, and, in addition, to provide an ink jet recording medium excellent in smoothness and a method for producing the same.

The present invention provides an ink jet recording medium which comprises a support, an undercoat layer provided on the support, and an ink-receiving layer provided thereon by coating a coating solution containing inorganic ultrafine particles, wherein the undercoat layer contains a salt of an alkaline earth metal and an adhesive.

Preferably, the content of the adhesive in the undercoat layer is 0.05-0.8 time that of the salt of the alkaline earth metal in weight ratio.

Preferably, the alkaline earth metal is calcium or magnesium, and, more preferably, the salt of the alkaline earth metal is a carbonate.

Preferably, the inorganic ultrafine particles are of an amorphous synthetic silica produced by a gas phase method or an alumina compound.

Preferably, the coating solution for the ink-receiving layer containing the inorganic ultrafine particles has a pH of not higher than 5.0.

It is a preferred embodiment that the undercoat layer contains the adhesive in an amount of 0.05-0.4 time the amount of the salt of the alkaline earth metal in weight ratio.

Furthermore, the present invention provides an ink jet recording medium which comprises a support, an undercoat layer provided on the support and an ink-receiving layer provided by coating a coating solution containing inorganic ultrafine particles on the undercoat layer, wherein the undercoat layer further contains an organic pigment in addition to the salt of alkaline earth metal and the adhesive.

Preferably, the alkaline earth metal is calcium or magnesium, and, more preferably, the salt of the alkaline earth metal is a carbonate.

It is a preferred embodiment that the undercoat layer contains the organic pigment in an amount of 0.05-20 times the amount of the salt of the alkaline earth metal in weight ratio.

Preferably, the organic pigment is a hollow organic pigment or a dense organic pigment, and it may be a mixture thereof. In the case of the mixture, it is a preferred embodiment that the amount of the dense organic pigment in the mixture is 0.1-10 times that of the hollow organic pigment in weight ratio.

Preferably, the organic pigment is a hollow organic pigment having an average void content of not less than 20%.

Preferably, the organic pigment is a bowl-shaped dense organic pigment.

Preferably, the organic pigment has an average particle diameter of 0.3-10 μm.

Preferably, the inorganic ultrafine particles are of an amorphous synthetic silica produced by a gas phase method or an alumina compound.

Preferably, the coating solution for ink-receiving layer containing the inorganic ultrafine particles has a pH of not higher than 5.0.

It is a preferred embodiment that the undercoat layer contains the adhesive in an amount of 0.05-0.8 time the total solid content of the salt of the alkaline earth metal and the organic pigment in weight ratio ratio.

Furthermore, the present invention provides a method for producing an ink jet recording medium which comprises providing an undercoat layer on a support and providing an ink-receiving layer thereon by coating a coating solution containing inorganic ultrafine particles on the undercoat layer, wherein the undercoat layer contains a salt of an alkaline earth metal and an adhesive in an amount of 0.05-0.8 time the amount of the salt of the alkaline earth metal, and after providing the undercoat layer, the undercoat layer is subjected to a hot calendering treatment and then the ink-receiving layer containing inorganic ultrafine particles is provided.

In addition, the present invention provides a method for producing an ink jet recording medium which comprises providing an undercoat layer on a support and providing an ink-receiving layer thereon by coating a coating solution containing inorganic ultrafine particles on the undercoat layer, wherein the undercoat layer contains a salt of an alkaline earth metal, an organic pigment and an adhesive in an amount of 0.05-0.8 time the total solid content of the salt of the alkaline earth metal and the organic pigment, and after providing the undercoat layer, the undercoat layer is subjected to a hot calendering treatment and then the ink-receiving layer containing inorganic ultrafine particles is provided.

In the method for producing the ink jet recording medium mentioned above, it is a preferred embodiment that the inorganic ultrafine particles are of an amorphous synthetic silica produced by a gas phase method or an alumina compound, and the coating solution for ink-receiving layer has a pH of not higher than 5.0.

### BEST MODE FOR CARRYING OUT THE INVENTION

The ink jet recording medium of the present invention and the method for producing the same will be explained in detail below.

The ink jet recording medium of the present invention comprises a support, an undercoat layer provided on the support and an ink-receiving layer containing inorganic ultrafine particles provided on the undercoat layer, and the inorganic ultrafine particles are preferably of silica produced by a gas phase method or alumina compound.

The undercoat layer of the present invention contains a salt of an alkaline earth metal. The alkaline earth metal in the present invention is a general term for beryllium, calcium, magnesium, strontium, barium and radium. The salts of alkaline earth metals include, for example, carbonates, silicates, borates, hydrochlorides, sulfates, organic acid salts, etc., and weak acid salts of low solubility are preferred because in many cases the coating solution for the undercoat layer is an aqueous solution. Especially preferred are carbonates, and examples thereof are calcium carbonate, magnesium carbonate, etc.

Particle shapes of the salts of alkaline earth metals are sea urchin shape, square shape, columnar shape, amorphous shape, spherical shape, etc., and all of them can be satisfactorily used.

The undercoat layer containing the salt of the alkaline earth metal contains an adhesive in an amount of 0.05-0.8 time the amount of the salt of the alkaline earth metal in weight ratio. More preferred range is 0.05-0.4 time. If the amount of the adhesive is less than 0.05 in weight ratio to that of the salt of the alkaline earth metal, adhesion is insufficient and separation occurs between the undercoat layer and the support or the ink-receiving layer. If the amount of the adhesive exceeds 0.8 time in weight ratio to that of the salt of the alkaline earth metal, absorption is deteriorated, which is not preferred.

When the undercoat layer of the present invention contains an organic pigment, examples of the organic pigment used are those which comprise thermoplastic resins such as polystyrene resins, styrene-acrylic resins, acrylic resins, polyethylene resins, vinyl acetate-based copolymer polyolefin resins, polypropylene resins, polyacetal resins, chlorinated polyether resins, and polyvinyl chloride resins. The organic pigments may have multi-layer structures of these resins. Of these resins, polystyrene resins, acrylic resins or styrene-acrylic resins are preferred.

Of these organic pigments, those which have an average particle diameter in the range of 0.3-10 μm are preferred. The average particle diameter is more preferably 0.3-6 μm. If the average particle diameter is less than 0.3 μm, the organic pigment is densely filled in the undercoat layer to damage ink absorption, which is not preferred. If the average particle diameter exceeds 10 μm, since the particle diameter of the organic pigment is large, the number of pores in the undercoat layer decreases to damage ink absorption, which is not preferred.

The shape of the organic pigment used in the present invention may be any of the shapes of dense sphere (namely, having no voids), hollow sphere, bowl, erythrocyte, confeitos, etc., and two or more of these shapes can be used in combination. From the viewpoint of ink absorption, preferred are hollow organic pigments having one or a plurality of void (hollow) portions in the particles and bowl-shaped dense organic pigments obtained by cutting a part of nearly true sphere hollow organic pigment. The average void content of the hollow organic pigments is preferably not less than 20%. The void content means a proportion of the volume of void portions in the volume of the organic pigment. As these hollow organic pigments and bowl-shaped dense organic pigments, there may be suitably used commercially available organic pigments. Examples of the commercially available hollow organic pigments are ROPAQUE HP-1055, HP-91, OP-84J and HP-433J (manufactured by Rohm & Haas Co., Ltd.), those of dense organic pigments are L8801 (manufactured by Asahi Kasei Kogyo K.K.) and ARTPEARL F-4P (manufactured by Negami Kogyo Co., Ltd.), and those of bowl-shaped dense organic pigments are V2005 (manufactured by Nippon Zeon Co., Ltd.), etc. In the case of using hollow organic pigments and dense organic pigments in admixture, it is preferred that the mixture comprises dense organic pigments in an amount of 0.1-10 times the amount of the hollow organic pigments in weight ratio.

In the embodiment of the present invention where the undercoat layer contains the organic pigment, the undercoat layer contains the organic pigment in an amount of 0.05-20 times the amount of the salt of the alkaline earth metal in weight ratio. The amount of the organic pigment is more preferably in the range of 0.05-6 times. If the amount of the organic pigment is less than 0.05 time the amount of the salt of the alkaline earth metal in weight ratio, gloss and smoothness are deteriorated, which is not preferred. If the amount of the organic pigment exceeds 20 times the amount of the salt of the alkaline earth metal in weight ratio, ink absorption is deteriorated, which is not preferred.

In the embodiment of the present invention where the undercoat layer contains the salt of the alkaline earth metal and the organic pigment, the undercoat layer contains the adhesive in an amount of 0.05-0.8 time the total solid content of the salt of the alkaline earth metal and the organic pigment in weight ratio. More preferred range is 0.05-0.4 time. If the amount of the adhesive is less than 0.05 in weight ratio, adhesion is insufficient and separation occurs between the undercoat layer and the support or the ink-receiving layer. If the amount of the adhesive exceeds 0.8 time the total solid content of the salt of the alkaline earth metal and the organic pigment in weight ratio, deterioration of absorption is caused, which is not preferred.

The adhesives contained in the undercoat layer include, for example, cellulose adhesives such as methyl cellulose, methylhydroxyethyl cellulose, methylhydroxypropyl cellulose and hydroxyethyl cellulose, natural polymeric resins or derivatives thereof such as starch and modified products thereof, gelatin and modified products thereof, casein, pullulan, gum arabic, and albumin, polyvinyl alcohol and modified products thereof, latexes or emulsions such as styrene-butadiene copolymer, styrene-acrylate copolymer, methyl methacrylate-butadiene copolymer, and ethylene-vinyl acetate copolymer, vinyl polymers such as polyacrylamide and polyvinyl pyrrolidone, polyethylene-imine, polypropylene glycol, polyethylene glycol, maleic anhydride or copolymers thereof, etc. Among them, copolymer emulsions are preferred.

Furthermore, acrylic resin adhesives which are synthetic resins obtained by polymerization of acrylic acid, acrylic esters, acrylonitrile, etc. and emulsions thereof are used as adhesives which give excellent gloss feeling to the printed portions since they are excellent in light resistance and inhibit discoloration, thereby resulting in improvement of light resistance of white paper portions of the ink jet recording medium and furthermore they are high in transparency. Particularly, emulsion type acrylic resin adhesives are excellent in adhesive strength.

Moreover, so long as the attainment of the object of the present invention is not hindered, there may be optionally added other additives such as cationic dye fixing agents, pigment dispersing agents, thickening agents, fluidity improving agents, viscosity stabilizers, pH adjustors, surface active agents, anti-foaming agents, foam inhibitors, releasing agents, foaming agents, penetrants, colored dyes, colored pigments, white inorganic pigments, white organic pigments, fluorescent brighteners, ultraviolet absorbers, antioxidants, leveling agents, preservatives, antifungal agents, water resisting agents, dry strengthening agents, and wet strengthening agents.

The method for coating the undercoat layer is not particularly limited, and known coating methods can be employed. For example, the undercoat layer can be coated on the support by various devices such as air knife coater, curtain coater, slide lip coater, die coater, blade coater, gate roll coater, bar coater, rod coater, roll coater, bill blade coater, short dwell blade coater, and size press.

Further, the coated undercoat layer may be smoothed by calendering treatment. In this case, the calendering treatments include, for example, gloss calendering, super calendering, soft calendering, etc. Hot calendering treatment which carries out the smoothing with heating is especially preferred.

Moreover, when a hot calendering treatment using a roll having rough surface is carried out as the calendering treatment of the undercoat layer to roughen the surface of the undercoat layer, gloss of the white paper of the surface of the recording medium decreases and glossy feeling can be given to the printed portions while having a matte surface.

In this case, if the roughness of the rough surface roll is too high, the smoothness of the surface of the recording medium is conspicuously reduced, resulting in deterioration of the printed image quality. Therefore, the roughness of the rough surface roll is preferably 1-40 μm, more preferably 1-30 μm in ten points average roughness (Rz) in accordance with JIS-B-0601.

The coating amount of the undercoat layer is not particularly limited, but if it is too small, the effect of the undercoat layer is not developed, and if it is too large, not only there are difficulties in production, but also the effect is saturated and economical efficiency is low. Therefore, the coating amount is preferably 5-30 g/m².

The inorganic ultrafine particles in the ink jet recording medium of the present invention are those which have a primary particle diameter of 100 nm or less and a secondary particle diameter of 400 nm or less. As typical examples of the inorganic ultrafine particles, mention may be made of pseudoboehmite sol which is an alumina hydrate as disclosed in JP-A-1-97678, JP-A-2-275510, JP-A-3-281383, JP-A-3-285814, JP-A-3-285815, JP-A-4-92183, JP-A-4-267180 and JP-A-4-275917, colloidal silica as disclosed in JP-A-60-219083, JP-A-61-19389, JP-A-61-188183, JP-A-63-178074 and JP-A-5-51470, silica/alumina hybrid sol as disclosed in JP-B-4-19037 and JP-A-62-286787, silica sol prepared by dispersing silica of gas phase method by high-speed homogenizer as disclosed in JP-A-10-119423 and JP-A-10-217601, and, additionally, smectite clays such as hectite and montmorillonite (JP-A-7-81210), zirconia sol, chromia sol, yttria sol, ceria sol, iron oxide sol, zircon sol, and antimony oxide sol.

Of these inorganic ultrafine particles, especially preferred are silica ultrafine particles prepared by gas phase method and alumina compounds (alumina hydrate or aluminum oxide ultrafine particles).

Silica fine particles are fine particles comprising 93% or more of SiO₂, about 5% or less of Al₂O₃ and about 5% or less of Na₂O on dry weight, and there are amorphous silica such as white carbon, silica gel and fine powder silica. The amorphous silica fine particles are produced by liquid phase method, grinding solid phase method, crystallization solid phase method and gas phase method. The liquid phase method is a method for the production of fine particles by precipitating in solid state a silicic acid compound present in so-called liquid by chemical change or physical change. The grinding solid phase method is a method of mechanically grinding a silica solid, and the crystallization solid phase method is a method for the production of fine particles utilizing melting or phase transition of solid. The gas phase method is a method for the production of fine particles by thermal decomposition of vapor of a volatile metal compound or by heating and evaporating the starting material, cooling and condensation of the vapor produced.

The silica fine particles used in the present invention are amorphous silica fine particles synthesized by the gas phase method. Among them, preferred are ultrafine particle silica having an average primary particle diameter of 3-50 nm. Especially preferred are those which have a primary particle diameter of 5-30 nm. Secondary particle diameter of the particles formed by linking of them is preferably 10-400 nm. Commercially available products of amorphous silica fine particles synthesized by the gas phase method are AEROSIL (manufactured by Degussa Co., Ltd.).

The silica obtained by the gas phase method used in the present invention is prepared by adding silica fine particles having the above primary particle diameter to water and dispersing them by a high-speed homogenizer or the like to an average secondary particle diameter of 400 nm or less, preferably 200 nm or less.

The alumina hydrates used in the present invention can be represented by the following formula.

Al₂O₃.nH₂O

The alumina hydrates can be classified into gibbsite, bialite, norstrandite, boehmite, boehmite gel (pseudoboehmite), diaspore, amorphous hydrate, etc. depending on the difference in composition or crystal form. When n is 1 in the above formula, the formula represents an alumina hydrate of boehmite structure, when n is more than 1 and less than 3, the formula represents alumina hydrate of pseudoboehmite structure, and when n is 3 or more, the formula represents alumina hydrate of amorphous structure. The alumina hydrate especially preferred in the present invention is of pseudoboehmite structure having the above formula where n is more than 1 and less than 3.

The shape of the alumina hydrate used in the present invention may be any of platy shape, fibrous shape, acicular shape, spherical shape and rod-like shape, and the platy shape is preferred from the point of ink absorption. The platy alumina hydrate has an average aspect ratio of 3-8, preferably 3-6. The aspect ratio is a ratio of “diameter” to “thickness” of the particles. The diameter of the particles here is a diameter of a circle having an area equal to projected area of the particles when observed by an electron microscope. If the aspect ratio is smaller than the above range, the pore diameter distribution of the ink-receiving layer becomes narrow and the ink absorption is deteriorated. If it is larger than the above range, it is difficult to produce an alumina hydrate with uniform particle size.

The alumina hydrate used in the present invention can be produced by known methods such as hydrolysis of an aluminum alkoxide such as aluminum isopropoxide, neutralization of an aluminum salt with an alkali, and hydrolysis of an aluminate. The physical properties of the alumina hydrate such as particle diameter, pore diameter, pore volume and specific surface area can be controlled by the conditions such as precipitation temperature, aging temperature, aging time, pH of solution, concentration of solution and coexisting compounds.

As a method for obtaining the alumina hydrate from an alkoxide, JP-A-57-88074, JP-A-62-56321, JP-A-4-275917, JP-A-6-64918, JP-A-7-10535, and JP-A-7-267633, and U.S. Pat. No. 2,656,321 disclose hydrolysis of an aluminum alkoxide. Examples of the aluminum alkoxides are isopropoxide and 2-butoxide.

Furthermore, JP-A-54-116398, JP-A-55-23034, JP-A-55-27824 and JP-A-56-120508 disclose methods of using inorganic salts of aluminum or hydrates thereof as starting materials. The starting materials include, for example, inorganic salts such as aluminum chloride, aluminum nitrate, aluminum sulfate, aluminum polychloride, ammonium alum, sodium alumiate, potassium aluminate and aluminum hydroxide, and hydrates of these salts.

As other methods, there are a method of growing crystals of alumina hydrate by alternately varying pH between acidic side and basic side as disclosed in JP-A-56-120508, and a method of mixing an alumina hydrate obtained from an inorganic salt of aluminum with alumina obtained by Bayer's method to carry out re-hydration of the alumina as disclosed in JP-B-4-33728.

Commercially available alumina hydrates can also be suitably used for the ink jet recording medium of the present invention. Examples of them are enumerated below, which do not limit the present invention.

The alumina hydrates include, for example, CATALOID AS-1, CATALOID AS-2 and CATALOID AS-3 (manufactured by Shokubai Kagaku Kogyo Co., Ltd.), ALUMINA SOL 100, ALUMINA SOL 200 and ALUMINA SOL 520 (manufactured by Nissan Chemical Industries, Ltd.), M-200 (manufactured by Mizusawa Chemical Industries, Ltd.), ALUMI SOL 10, ALUMI SOL 20, ALUMI SOL 132, ALUMI SOL 132S, ALUMI SOL SH5, ALUMI SOL CSA55, ALUMI SOL SV102 and ALUMI SOL SB52 (manufactured by Kawaken Fine Chemical Co., Ltd.).

The aluminum oxide (hereinafter referred to as “alumina”) ultrafine particles used in the present invention are preferably γ-type alumina fine particles which are γ-type crystals. The γ-type crystals can be crystallographically classified into γ group and δ group. The fine particles having the crystal form of the δ group are preferred.

The γ-type alumina fine particles can be reduced to about 10 nm in average particle diameter of primary particles, but the primary particles generally form a secondary agglomerate (hereinafter referred to as “secondary particles”) and increase in particle diameter to several thousand nm—several ten thousand nm. When γ-type alumina fine particles of such large particle diameter are used, printability and absorption of ink-receiving layer are satisfactory, but the ink-receiving layer lacks transparency and defects are apt to occur in the coat. Average particle diameter of the primary particles is preferably less than 80 nm. If secondary particles comprising primary particles of 80 nm or more are used, fragility increases and defects occur very often in the coat.

For obtaining a sol of γ-type alumina fine particles, usually, γ-type alumina crystals which are usually in the form of secondary particles of several thousand nm to several ten thousand nm are ground to ultrafine particles having an average particle diameter of 200 nm or less, preferably 100 nm or less by grinding means such as beads mill, ultrasonic homogenizer and high-pressure type homogenizer. If the average particle diameter is more than 200 nm, ink absorption increases, but the coat is fragile and deteriorated in transparency. The grinding means are preferably ultrasonic homogenizer and high-pressure type homogenizer, and in the case of using other grinding methods such as beads mill, foreign matters are apt to enter into the sol from the grinding vessel since the γ-type alumina crystals are hard crystals, resulting in reduction of transparency and occurrence of defects. The γ-type alumina fine particles are excellent in ink absorption, superior in printing quality such as drying properties and ink fixing properties, and by making them to ultrafine particles, they can give ink jet recording media excellent in transparency even if they are contained in ink-receiving layer at a high proportion.

The γ-type alumina fine particles are commercially available, for example, as aluminum oxide C (manufactured by Japan Aerosil Co., Ltd.) belonging to 6 group and AKP-G015 (manufactured by Sumitomo Chemical Co., Ltd.) belonging to y group.

Water-soluble or water-insoluble polymer compounds may be added as adhesives for the inorganic ultrafine particles used in the present invention. The polymer compounds used in the present invention as a constitutive component of the ink-receiving layer are compounds which have affinity for ink. As examples of the water-soluble polymer compounds, mention may be made of cellulose adhesives such as methyl cellulose, methylhydroxyethyl cellulose, methylhydroxypropyl cellulose and hydroxyethyl cellulose, natural polymeric resins or derivatives thereof such as starch and modified products thereof, gelatin and modified products thereof, casein, pullulan, gum arabic, and albumin, polyvinyl alcohol and modified products thereof, latexes or emulsions such as styrene-butadiene copolymer, styrene-acrylate copolymer, methyl methacrylate-butadiene copolymer, and ethylene-vinyl acetate copolymer, vinyl polymers such as polyacrylamide and polyvinyl pyrrolidone, polyethyleneimine, polypropylene glycol, polyethylene glycol, maleic anhydride or copolymers thereof, etc. Polvyvinyl alcohol is preferred.

As the water-insoluble polymer compounds, water-insoluble adhesives soluble in alcohols such as ethanol and 2-propanol or mixed solvents of the alcohols and water are preferred because dispersion of alumina is stabilized. Examples of such water-insoluble adhesives are vinyl pyrrolidone/vinyl acetate copolymer, and acetal resins such as polyvinyl butyral and polyvinyl formal. Acetal resins of 5-20 mol % in acetalization degree are especially preferred because they can contain water to some extent and can make easy the dispersion of the inorganic ultrafine particles.

These polymer compounds may be used each alone or in combination, and are added in an amount of 2-50% by weight, preferably 5-30% by weight based on the inorganic ultrafine particles. If the amount is less than the above range, strength of the coat is low and if it is more than the above range, ink absorption decreases.

For coating the coating solution, various coating methods can be employed, such as E-bar coating, curtain coating, straddle hopper coating, extrusion coating, roll coating, air knife coating, gravure coating and rod bar coating.

In the present invention, the construction of the ink-receiving layer may be a single layer construction or laminated layer construction. In the case of the laminated layer construction, all of the layers may comprise the same composition or the layers may comprise different compositions.

The coating amount of the ink-receiving layer containing the inorganic ultrafine particles must be not less than 5 g/m² in terms of solid content, and in order to attain the higher effects of the present invention, it is preferably 10-30 g/m², and especially preferably 10-20 g/m². Though it depends on the void content, the thickness is preferably 10-30 μm.

Furthermore, a back coat layer may be provided on the side of the support opposite to the side having the ink-receiving layer for inhibition of curling by balancing expansion and contraction of the undercoat layer and the ink-receiving layer.

When the back coat layer is provided, thickness of the layer is preferably 5-30 μm, and more preferably the back coat layer contains inorganic pigment and/or spherical organic pigment.

Drying method after completion of coating is not limited, and generally known methods can be employed. For example, there are a method of introducing the coated support into a heating vessel through which a heating air generated by a heating source is passed and a method of passing the coated support near a heat source such as heater.

Further, the coating solution used for forming the ink-receiving layer containing inorganic ultrafine particles and optionally the adhesives can contain various known additives such as surface active agents, inorganic pigments, colored dyes, colored pigments, ink dye fixing agents (cationic resins), ultraviolet absorbers, antioxidants, dispersing agents for pigments, anti-foaming agents, leveling agents, preservatives, fluorescent brighteners, viscosity stabilizers, pH adjustors, and hardeners.

According to the present invention, an ink jet recording medium having high gloss, high ink absorption and excellent image colorfulness and being high in adhesion of ink-receiving layer can be obtained by providing an undercoat layer which contains a salt of an alkaline earth metal and an adhesive in an amount of 0.05-0.8 time that of the salt of alkaline earth metal in weight ratio or an undercoat layer which contains a salt of an alkaline earth metal, an organic pigment and an adhesive, and an ink-receiving layer containing inorganic ultrafine particles on the undercoat layer. It is not clear why the above combination can give the high gloss and the high absorption. In order to obtain high gloss, it is necessary that the ink-receiving layer does not penetrate into the undercoat layer at the time of coating of the ink-receiving layer and a highly smooth surface is formed by leveling and drying the surface. In order to obtain high absorption, it is necessary that not only the ink-receiving layer, but also the undercoat layer contribute to absorption, but if absorption of the undercoat layer is too high, there occurs a contradiction that the coating solution for the ink-receiving layer penetrates into the undercoat layer at the time of coating of the ink-receiving layer and, as a result, high gloss cannot be obtained.

It is considered that when the pigment in the undercoat layer is a salt of an alkaline earth metal and the coating solution for the ink-receiving layer is acidic as in the present invention, the acid in the ink-receiving layer and the salt of alkaline earth metal bring about a shock at the time of coating of the ink-receiving layer, and, hence, the inorganic ultrafine particles do not penetrate into the undercoat layer and an interface is formed, and it is further considered that during or after drying, the salt of alkaline earth metal at the interface-or in the undercoat layer is gradually dissolved or modified with the water or acid in the ink-receiving layer to form an absorption route, whereby ink absorption of the undercoat layer links with voids of the ink-receiving layer to enhance the absorption. Therefore, the coating solution for the ink-receiving layer is preferably in acidic area. The pH of the coating solution for the ink-receiving layer is preferably not higher than 5.0, and especially preferably not higher than 4.0. If the pH of the coating solution for the ink-receiving layer exceeds 5.0, interaction with the salt of alkaline earth metal is weak and the ink absorption tends to decrease. If the coating solution is in alkaline area, the effect is hardly developed.

The support used in the present invention has no special limitation so long as the undercoat layer and the ink-receiving layer can be coated thereon, but is preferably a paper support. The pulp which constitutes the paper which is preferred in the present invention includes one or more of natural pulp, regenerated pulp, synthetic pulp, etc. As the natural pulps, there may be used those which are generally used for making paper, namely, bleached chemical pulps such as softwood kraft pulp, hardwood kraft pulp, softwood sulfite pulp and hardwood sulfite pulp. Furthermore, mechanical pulps high in whiteness may also be used. Moreover, non-wood pulps, e.g. plant fibers such as straw, esparto, bagasse and kenaf, bast fibers such as hemp, paper mulbery, ganpi (Diplomorha sikokiana Honda) and mitsumata (Edgeworthia papyrifera Sieb. et. Zucc.), and cotton. Among them, most preferred are bleached chemical pulps such as softwood kraft pulp, hardwood kraft pulp, softwood sulfite pulp and hardwood sulfite pulp which are most widely used in industry.

The pulp is usually beaten by a beater such as a double disk refiner in order to improve suitability in paper-making and various characteristics of paper such as strength, smoothness and uniformity of texture. The degree of beating can be selected depending on the purpose within the usual range of 250-550 ml in Canadian standard freeness.

The beaten pulp slurry is made into paper by paper machines such as Fourdrinier paper machine, twin-wire paper machine and cylinder paper machine. In this case, in the present invention, there may be added all of the additives generally used in making paper, such as dispersion aids for pulp slurry, dry strengthening agents, wet strengthening agents, loading materials, sizing agents, and fixing agents. Moreover, if necessary, pH adjustors, dyes, colored pigments, fluorescent brighteners, etc. may also be added.

The dispersion aids include, for example, polyethylene oxide, polyacrylamide and hibiscus; the strengthening agents include, for example, anionic strengthening agents such as vegetable gum, starch and carboxy-modified polyvinyl alcohol and cationic strengthening agents such as cationized starch, cationic polyacrylamide and polyamide-polyamine-epichlorohydrin resin; the loading materials include, for example, clay, kaolin, talc, heavy calcium carbonate, precipitated calcium carbonate, barium sulfate, titanium oxide, aluminum hydroxide and magnesium hydroxide; the sizing agents include, for example, higher fatty acid salts, rosin, rosin derivative such as maleinized rosin, dialkylketene dimer, alkenyl or alkyl succinates, epoxidized fatty acid amide and polysaccharide ester; the fixing agents include, for example, polyvalent metal salts such as aluminum sulfate and aluminum chloride, and cationic polymers such as cationized starch, polyamide-polyamine-epichlorohydrin resin; and the pH adjustors include, for example, hydrochloric acid, sodium hydroxide and sodium carbonate.

Furthermore, the paper support used preferably in the present invention can be coated with a liquid containing various additives such as water-soluble polymer additives by tub-sizing, size press, a gate roll coater, a film transfer coater, etc.

The above water-soluble polymer additives include, for example, water-soluble polymeric adhesives, e.g., starch, starch derivatives such as cationized starch, oxidized starch, etherified starch and phosphoric acid-esterified starch, polyvinyl alcohol, polyvinyl alcohol derivatives such as carboxy-modified polyvinyl alcohol, cellulose derivatives such as carboxymethyl cellulose, hydroxymethyl cellulose, hydroxyethyl cellulose and cellulose sulfate, water-soluble natural polymers such as gelatin, casein and soybean protein, water-soluble polymers such as sodium polyacrylate, styrene-maleic anhydride copolymer sodium salt, sodium polystyrenesulfonate and maleic anhydride resin, and thermosetting synthetic resins such as elamin resin and urea resin. In addition, as the sizing agents, mention may be made of petroleum resin emulsion, ammonium salt of styrene-maleic anhydride copolymer alkyl ester, alkylketene dimer emulsion, and dispersions of styrene-butadiene copolymer, ethylene-vinyl acetate copolymer, polyethylene, and polyvinylidene chloride. Other additives include inorganic electrolytes such as sodium chloride, calcium chloride and Glauber's salt as antistatic agents; glycerin and polyethylene glycol as hygroscopic materials; clay, kaolin, talc, barium sulfate and titanium oxide as pigments; and hydrochloric acid, sodium hydroxide and sodium carbonate as pH adjustors. Furthermore, additives such as dyes, fluorescent brighteners, antioxidants, and ultraviolet absorbers may also be used in combination.

The paper support used in the present invention is preferably one which has high surface smoothness given by compression with application of pressure by calender and others during or after paper-making. Especially preferred is one which has a Beck smoothness of not less than 50 seconds, especially preferably not less than 100 seconds measured in accordance with JIS P-8119. The basis weight of the paper support is preferably 70-300 g/m², more preferably 150-300 g/m². The density is suitably not less than 0.90 g/cm³. Moreover, the water absorption amount measured by Cobb method (contact time: 30 seconds) specified in JIS-P-8140 is suitably not more than 25 g/m², and the air permeability measured by Gurley densometer specified in JIS-P-8117 is suitably not less than 100 seconds/100 ml.

In case the density of the paper support used in the present invention is less than 0.90 g/cm³, it is suitable that the paper support contains a wet strengthening agent.

Furthermore, when a paper support is used in the present invention, a barrier layer containing a pigment and an adhesive may be provided between the base paper and the undercoat layer in order to prevent the ink solvent from reaching the base paper, thereby obtaining an ink jet recording medium which is less in surface waviness after recording of images and is attractive in appearance.

### EXAMPLES

The present invention will be explained by the following examples, which should not be construed as limiting the invention in any manner. All parts and % are by weight.

<Production of Support>

A mixture (1:1) of a hardwood bleached kraft pulp (LBKP, whiteness: 90%) and a softwood bleached sulfite pulp (NBSP, whiteness: 90%) was beaten until the Canadian standard freeness reached 300 ml, thereby to prepare a pulp slurry. To the resulting pulp slurry were added alkyl ketene dimer as a sizing agent in an amount of 0.5% by weight based on the pulp, polyacrylamide as a strengthening agent in an amount of 1.0% by weight based on the pulp, cationized starch in an amount of 2.0% by weight based on the pulp and polyamide-epichlorohydrin resin in an amount of 0.5% by weight based on the pulp, followed by diluting with water to obtain a 1% slurry. The resulting slurry was subjected to paper making process using a Fourdrinier paper machine to make a paper, and the paper was subjected to wet pressing of 3 stages at the wet part, then to a treatment by a smoothing roll, and to a stretch pressing of 2 stages in the course of the subsequent dry part. Thereafter, in the course of drying, the paper was subjected to size press coating with 20 g/m² of a size press solution containing 5% by weight of carboxy-modified polyvinyl alcohol and dried so that the water content in the finally obtained base paper reached 8% by weight in absolute dry water content. Then, this was subjected to machine calendering to make a paper of 170 g/m² in basis weight, thereby obtaining a paper support. This paper support had a Beck smoothness of 110 seconds.

<Preparation of Coating Solutions 1a-1h for Undercoat Layer>

100 Parts of precipitated calcium carbonate (TAMAPEARL 222H manufactured by Okutama Kogyo Co., Ltd.) as a salt of an alkaline earth metal and 3 parts, 5 parts, 10 parts, 15 parts, 20 parts, 40 parts, 80 parts, or 100 parts in solid content of a styrene-butadiene copolymer latex (LACSTAR DS226 manufactured by Dainippon Ink & Chemicals Inc.) as an adhesive were mixed with water to prepare coating solutions 1a-1h having a solid concentration of 45% for undercoat layer.

<Preparation of Coating Solution 2 for Undercoat Layer>

100 Parts of heavy calcium carbonate (CARBITAL 90 manufactured by ECC International Co., Ltd.) as a salt of an alkaline earth metal and 20 parts in solid content of a styrene-butadiene copolymer latex (LACSTAR DS226 manufactured by Dainippon Ink & Chemicals Inc.) as an adhesive were mixed with water to prepare a coating solution 2 having a solid concentration of 45% for undercoat layer.

<Preparation of Coating Solution 3 for Undercoat Layer>

100 Parts of magnesium carbonate (Spherical magnesium carbonate manufactured by Kamishima Kagaku Kogyo Co., Ltd.) as a salt of an alkaline earth metal and 20 parts in solid content of a styrene-butadiene copolymer latex (LACSTAR DS226 manufactured by Dainippon Ink & Chemicals Inc.) as an adhesive were mixed with water to prepare a coating solution 3 having a solid concentration of 45% for undercoat layer.

<Preparation of Coating Solution 4 for Undercoat Layer>

100 Parts of barium sulfate (Precipitated barium sulfate D-2 manufactured by Baryte Kogyo Co., Ltd.) as a salt of an alkaline earth metal and 20 parts in solid content of a styrene-butadiene copolymer latex (LACSTAR DS226 manufactured by Dainippon Ink & Chemicals Inc.) as an adhesive were mixed with water to prepare a coating solution 4 having a solid concentration of 45% for undercoat layer.

<Preparation of Coating Solution 5 for Undercoat Layer>

100 Parts of synthetic amorphous silica (FINESIL X37B manufactured by Tokuyama Co., Ltd.) and 20 parts of polyvinyl alcohol (PVA 117 manufactured by Kuraray Co., Ltd.) as an adhesive were dissolved in and mixed with water to prepare a coating solution 5 having a solid concentration of 20% for undercoat layer.

<Preparation of Coating Solution 6a for Undercoat Layer>

80 Parts of precipitated calcium carbonate (TAMAPEARL 222H manufactured by Okutama Kogyo Co., Ltd.) as a salt of an alkaline earth metal, 20 parts of a hollow organic pigment (ROPAQUE HP-91 manufactured by Rohm & Haas Co.; average particle diameter: 1.0 μm, average void content: 50%) and 20 parts in solid content of a styrene-butadiene copolymer latex (LACSTAR DS226 manufactured by Dainippon Ink & Chemicals Inc.) as an adhesive were mixed with water to prepare a coating solution 6a having a solid concentration of 45% for undercoat layer.

<Preparation of Coating Solution 6b for Undercoat Layer>

50 Parts of precipitated calcium carbonate (TAMAPEARL 222H manufactured by Okutama Kogyo Co., Ltd.) as a salt of an alkaline earth metal, 50 parts of a hollow organic pigment (ROPAQUE HP-91 manufactured by Rohm & Haas Co.; average particle diameter: 1.0 μm, average void content: 50%) and 20 parts in solid content of a styrene-butadiene copolymer latex (LACSTAR DS226 manufactured by Dainippon Ink & Chemicals Inc.) as an adhesive were mixed with water to prepare a coating solution 6b having a solid concentration of 45% for undercoat layer.

<Preparation of Coating Solution 6c for Undercoat Layer>

20 Parts of precipitated calcium carbonate (TAMAPEARL 222H manufactured by Okutama Kogyo Co., Ltd.) as a salt of an alkaline earth metal, 80 parts of a hollow organic pigment (ROPAQUE HP-91 manufactured by Rohm & Haas Co.; average particle diameter: 1.0 μm, average void content: 50%) and 20 parts in solid content of a styrene-butadiene copolymer latex (LACSTAR DS226 manufactured by Dainippon Ink & Chemicals Inc.) as an adhesive were mixed with water to prepare a coating solution 6c having a solid concentration of 45% for undercoat layer.

<Preparation of Coating Solution 7 for Undercoat Layer>

80 Parts of heavy calcium carbonate (CARBITAL 90 manufactured by ECC International Co., Ltd.) as a salt of an alkaline earth metal, 20 parts of a hollow organic pigment (ROPAQUE HP-91 manufactured by Rohm & Haas Co.; average particle diameter: 1.0 μm, average void content: 50%) and 20 parts in solid content of a styrene-butadiene copolymer latex (LACSTAR DS226 manufactured by Dainippon Ink & Chemicals Inc.) as an adhesive were mixed with water to prepare a coating solution 7 having a solid concentration of 45% for undercoat layer.

<Preparation of Coating Solution 8 for Undercoat Layer>

80 Parts of magnesium carbonate (Spherical magnesium carbonate manufactured by Kamishima Kagaku Kogyo Co., Ltd.) as a salt of an alkaline earth metal, 20 parts of a hollow organic pigment (ROPAQUE HP-91 manufactured by Rohm & Haas Co.; average particle diameter: 1.0 μm, average void content: 50%) and 20 parts in solid content of a styrene-butadiene copolymer latex (LACSTAR DS226 manufactured by Dainippon Ink & Chemicals Inc.) as an adhesive were mixed with water to prepare a coating solution 8 having a solid concentration of 45% for undercoat layer.

<Preparation of Coating Solution 9 for Undercoat Layer>

80 Parts of kaolin (UW90 manufactured by Engelhard Co., Ltd.), 20 parts of a hollow organic pigment (ROPAQUE HP-91 manufactured by Rohm & Haas Co.; average particle diameter: 1.0 μm, average void content: 50%) and 20 parts in solid content of a styrene-butadiene copolymer latex (LACSTAR DS226 manufactured by Dainippon Ink & Chemicals Inc.) as an adhesive were mixed with water to prepare a coating solution 9 having a solid concentration of 45% for undercoat layer.

<Preparation of Coating Solution 10 for Undercoat Layer>

100 Parts of a hollow organic pigment (ROPAQUE-HP-91 manufactured by Rohm & Haas Co.; average particle diameter: 1.0 μm, average void content: 50%) and 20 parts in solid content of a styrene-butadiene copolymer latex (LACSTAR DS226 manufactured by Dainippon Ink & Chemicals Inc.) as an adhesive were mixed with water to prepare a coating solution 10 having a solid concentration of 45% for undercoat layer.

<Preparation of Coating Solution 11 for Undercoat Layer>

80 Parts of precipitated calcium carbonate (TAMAPEARL 222H manufactured by Okutama Kogyo Co., Ltd.) as a salt of an alkaline earth metal, 20 parts of a hollow organic pigment (ROPAQUE OP-84J manufactured by Rohm & Haas Co.; average particle diameter: 0.55 μm, average void content: 25%) and 20 parts in solid content of a styrene-butadiene copolymer latex (LACSTAR DS226 manufactured by Dainippon Ink & Chemicals Inc.) as an adhesive were mixed with water to prepare a coating solution 11 having a solid concentration of 45% for undercoat layer.

<Preparation of Coating Solution 12 for Undercoat Layer>

80 Parts of precipitated calcium carbonate (TAMAPEARL 222H manufactured by Okutama Kogyo Co., Ltd.) as a salt of an alkaline earth metal, 20 parts of a dense organic pigment (L8801 manufactured by Asahi Kasei Kogyo K.K.; average particle diameter: 0.5 μm) and 20 parts in solid content of a styrene-butadiene copolymer latex (LACSTAR DS226 manufactured by Dainippon Ink & Chemicals Inc.) as an adhesive were mixed with water to prepare a coating solution 12 having a solid concentration of 45% for undercoat layer.

<Preparation of Coating Solution 13 for Undercoat Layer>

80 Parts of precipitated calcium carbonate (TAMAPEARL 222H manufactured by Okutama Kogyo Co., Ltd.) as a salt of an alkaline earth metal, 20 parts of a dense organic pigment (ARTPEARL F-4P manufactured by Negami Kogyo Co., Ltd.; average particle diameter: 2.1 μm) and 20 parts in solid content of a styrene-butadiene copolymer latex (LACSTAR DS226 manufactured by Dainippon Ink & Chemicals Inc.) as an adhesive were mixed with water to prepare a coating solution 13 having a solid concentration of 45% for undercoat layer.

<Preparation of Coating Solution 14 for Undercoat Layer>

80 Parts of precipitated calcium carbonate (TAMAPEARL 222H manufactured by Okutama Kogyo Co., Ltd.) as a salt of an alkaline earth metal, 20 parts of a bowl-shaped dense organic pigment (V2005 manufactured by Nippon Zeon Co., Ltd.; average particle diameter: 0.8 μm) and 20 parts in solid content of a styrene-butadiene copolymer latex (LACSTAR DS226 manufactured by Dainippon Ink & Chemicals Inc.) as an adhesive were mixed with water to prepare a coating solution 14 having a solid concentration of 45% for undercoat layer.

<Preparation of Coating Solution 15a for Undercoat Layer>

80 Parts of precipitated calcium carbonate (TAMAPEARL 222H manufactured by Okutama Kogyo Co., Ltd.) as a salt of an alkaline earth metal, 5 parts of a hollow organic pigment (ROPAQUE OP-84J manufactured by Rohm & Haas Co.; average particle diameter: 0.55 μm, average void content: 25%), 15 parts of a dense organic pigment (L8801 manufactured by Asahi Kasei Kogyo K.K.; average particle diameter: 0.5 μm) and 20 parts in solid content of a styrene-butadiene copolymer latex (LACSTAR DS226 manufactured by Dainippon Ink & Chemicals Inc.) as an adhesive were mixed with water to prepare a coating solution 15a having a solid concentration of 45% for undercoat layer.

<Preparation of Coating Solution 15b for Undercoat Layer>

80 Parts of precipitated calcium carbonate (TAMAPEARL 222H manufactured by Okutama Kogyo Co., Ltd.) as a salt of an alkaline earth metal, 10 parts of a hollow organic pigment (ROPAQUE OP-84J manufactured by Rohm & Haas Co.; average particle diameter: 0.55 μm, average void content: 25%), 10 parts of a dense organic pigment (L8801 manufactured by Asahi Kasei Kogyo K.K.; average particle diameter: 0.5 μm) and 20 parts in solid content of a styrene-butadiene copolymer latex (LACSTAR DS226 manufactured by Dainippon Ink & Chemicals Inc.) as an adhesive were mixed with water to prepare a coating solution 15b having a solid concentration of 45% for undercoat layer.

<Preparation of Coating Solution 15c for Undercoat Layer>

80 Parts of precipitated calcium carbonate (TAMAPEARL 222H manufactured by Okutama Kogyo Co., Ltd.) as a salt of an alkaline earth metal, 15 parts of a hollow organic pigment (ROPAQUE OP-84J manufactured by Rohm & Haas Co.; average particle diameter: 0.55 μm, average void content: 25%), 5 parts of a dense organic pigment (L8801 manufactured by Asahi Kasei Kogyo K.K.; average particle diameter: 0.5 μm) and 20 parts in solid content of a styrene-butadiene copolymer latex (LACSTAR DS226 manufactured by Dainippon Ink & Chemicals Inc.) as an adhesive were mixed with water to prepare a coating solution 15c having a solid concentration of 45% for undercoat layer.

<Preparation of Coating Solutions 16a-16d for Undercoat Layer>

80 Parts of precipitated calcium carbonate (TAMAPEARL 222H manufactured by Okutama Kogyo Co., Ltd.) as a salt of an alkaline earth metal, 20 parts of a hollow organic pigment (ROPAQUE HP-91 manufactured by Rohm & Haas Co.; average particle diameter: 1.0 μm, average void content: 50%) and 3 parts, 5 parts, 80 parts or 100 parts in solid content of a styrene-butadiene copolymer latex (LACSTAR DS226 manufactured by Dainippon Ink & Chemicals Inc.) as an adhesive were mixed with water to prepare coating solutions 16a-16d having a solid concentration of 45% for undercoat layer.

<Preparation of Coating Solution 17 for Undercoat Layer>

80 Parts of precipitated calcium carbonate (TAMAPEARL 222H manufactured by Okutama Kogyo Co., Ltd.) as a salt of an alkaline earth metal, 20 parts of a dense organic pigment (L8999 manufactured by Asahi Kasei Kogyo K.K.; average particle diameter: 0.2 μm) and 20 parts in solid content of a styrene-butadiene copolymer latex (LACSTAR DS226 manufactured by Dainippon Ink & Chemicals Inc.) as an adhesive were mixed with water to prepare a coating solution 17 having a solid concentration of 45% for undercoat layer.

<Preparation of Coating Solution 18 for Undercoat Layer>

80 Parts of precipitated calcium carbonate (TAMAPEARL 222H manufactured by Okutama Kogyo Co., Ltd.) as a salt of an alkaline earth metal, 20 parts of a dense organic pigment (CHEMIPEARL V-100 manufactured by Mitsui Chemical Co., Ltd.; average particle diameter: 12.0 μm) and 20 parts in solid content of a styrene-butadiene copolymer latex (LACSTAR DS226 manufactured by Dainippon Ink & Chemicals Inc.) as an adhesive were mixed with water to prepare a coating solution 18 having a solid concentration of 45% for undercoat layer.

<Coating Solution A for ink-Receiving Layer>

100 Grams of ultrafine particle silica having a primary particle diameter of 7 nm produced by a gas phase method (AEROSIL 300 manufactured by Japan Aerosil Co., Ltd.) and 3 g of a dispersing agent (SHALLOL DC902P manufactured by Daiichi Kogyo Seiyaku Co., Ltd.) were dispersed in 500 g of deionized water by a stirrer to obtain a dispersion having a secondary particle diameter of 200 nm or less. 100 Parts of this dispersion of ultrafine particle silica produced by gas phase method was mixed with 15 parts of 10 wt % aqueous solution of polyvinyl alcohol (PVA 105 manufactured by Kuraray Co., Ltd.), followed by adding water to prepare a coating solution A having a solid concentration of 15% for ink-receiving layer. The resulting coating solution A for ink-receiving layer had a pH of 3.8.

<Synthesis of Alumina Hydrate>

1200 Grams of deionized water and 900 g of isopropyl alcohol were charged in a reaction vessel of 3 L, and heated to 75° C. Thereto was added 408 g of aluminum isopropoxide, and hydrolysis was carried out at 75° C. for 24 hours and, successively, at 95° C. for 10 hours. After completion of the hydrolysis, 24 g of acetic acid was added, followed by stirring at 95° C. for 48 hours and, then, concentrating to a solid concentration of 15% by weight to obtain a white dispersion of ultrafine particle alumina hydrate. This sol was dried at room temperature and subjected to X-ray diffraction to show pseudoboehmite structure. Furthermore, primary particle diameter was measured by a transmission type electron microscope to obtain 30 nm, and the alumina hydrate was a platy ultrafine particle alumina hydrate having an aspect ratio of 6.0. Moreover, average pore radius, pore volume and BET specific surface area were measured by nitrogen adsorption and desorption method to obtain 7.1 nm, 0.65 ml/g and 200 m²/g, respectively.

<Coating Solution B for Ink-Receiving Layer>

The above dispersion of ultrafine particle alumina hydrate of 15% by weight in concentration was dispersed using a homomixer so that the secondary particle diameter reached 400 nm or less, and, further, 100 parts of this dispersion of alumina hydrate was mixed with 15 parts of 10 wt % aqueous solution of polyvinyl alcohol (PVA 105 manufactured by Kuraray Co., Ltd.). The resulting mixed liquid was concentrated to a solid concentration of 15% by an evaporator, thereby to obtain a coating solution B for ink-receiving layer. The resulting coating solution B for ink-receiving layer had a pH of 4.5.

<Coating Solution C for Ink-Receiving Layer>

600 Grams of Aerosil Aluminum Oxide C (manufactured by Japan Aerosil Co., Ltd.) of 13 nm in primary particle diameter which was γ-type alumina crystal powder of δ group as alumina ultrafine particles was dispersed in 2400 g of deionized water by a homo-mixer so that the secondary particle diameter reached 100 nm or less, thereby to prepare a 20 wt % viscous solution in the form of slurry. 100 Parts of this γ-type alumina dispersion of 20% by weight in concentration was mixed with 30 parts of 10 wt % aqueous solution of polyvinyl alcohol (PVA 235 manufactured by Kuraray Co., Ltd.). Water was added thereto to obtain a coating solution C having a solid concentration of 15% for ink-receiving layer. The resulting coating solution C for ink-receiving layer had a pH of 5.0.

<Coating Solution D for Ink-Receiving Layer>

100 Grams of ultrafine particle silica having a primary particle diameter of 7 nm produced by gas phase method (AEROSIL 300 manufactured by Japan Aerosil Co., Ltd.) and 3 g of a dispersing agent (SHALLOL DC902P manufactured by Daiichi Kogyo Seiyaku Co., Ltd.) were dispersed in 500 g of deionized water by a stirrer to obtain a dispersion having a secondary particle diameter of 200 nm or less. 100 Parts of this dispersion of ultrafine particle silica produced by gas phase method was mixed with 15 parts of 10 wt % aqueous solution of polyvinyl alcohol (PVA 105 manufactured by Kuraray Co., Ltd.), followed by adding sodium hydroxide to adjust the pH to 5.5 and adding water to prepare a coating solution D having a solid concentration of 15% for ink-receiving layer.

<Coating Solution E for Ink-Receiving Layer>

100 Parts of a synthetic amorphous silica having a secondary particle diameter of 3.7 μm (FINESIL X-37B manufactured by Tokuyama Co., Ltd.; BET specific surface area: 270 m²/g) which was not the inorganic ultrafine particles of the present invention, 15 parts of polyvinyl alcohol (PVA 105 manufactured by Kuraray Co., Ltd.) and 20 parts of a cationic dye fixing agent (SUMIREZ RESIN 1001 manufactured by Sumitomo Chemical Co., Ltd.) were dissolved in water and mixed to obtain a coating solution E having a solid concentration of 15% for ink-receiving layer. The coating solution E for ink-receiving layer had a pH of 5.3.

### EXAMPLE 1

The coating solution 1b for undercoat layer was coated on the paper support produced above in an amount of 15 g/m² in dry solid content by an air knife coater, followed by drying the coat. Then, on the resulting undercoat layer was coated the coating solution A for ink-receiving layer in an amount of 15 g/m² in dry solid content by a curtain coater, followed by drying to obtain a recording medium of Example 1.

### EXAMPLE 2

A recording medium of Example 2 was produced in the same manner as in Example 1, except that the coating solution 1c for undercoat layer was used in place of the coating solution 1b for undercoat layer in Example 1.

### EXAMPLE 3

A recording medium of Example 3 was produced in the same manner as in Example 1, except that the coating solution 1d for undercoat layer was used in place of the coating solution 1b for undercoat layer in Example 1.

### EXAMPLE 4

A recording medium of Example 4 was produced in the same manner as in Example 1, except that the coating solution 1e for undercoat layer was used in place of the coating solution 1b for undercoat layer in Example 1.

### EXAMPLE 5

A recording medium of Example 5 was produced in the same manner as in Example 1, except that the coating solution 1f for undercoat layer was used in place of the coating solution 1b for undercoat layer in Example 1.

### EXAMPLE 6

A recording medium of Example 6 was produced in the same manner as in Example 1, except that the coating solution 1g for undercoat layer was used in place of the coating solution 1b for undercoat layer in Example 1.

### COMPARATIVE EXAMPLE 1

A recording medium of Comparative Example 1 was produced in the same manner as in Example 1, except that the coating solution 1a for undercoat layer was used in place of the coating solution 1b for undercoat layer in Example 1.

### COMPARATIVE EXAMPLE 2

A recording medium of Comparative Example 2 was produced in the same manner as in Example 1, except that the coating solution 1h for undercoat layer was used in place of the coating solution 1b for undercoat layer in Example 1.

### EXAMPLE 7

A recording medium of Example 7 was produced in the same manner as in Example 1, except that the coating solution 2 for undercoat layer was used in place of the coating solution 1b for undercoat layer in Example 1

### EXAMPLE 8

A recording medium of Example 8 was produced in the same manner as in Example 1, except that the coating solution 3 for undercoat layer was used in place of the coating solution 1b for undercoat layer in Example 1.

### EXAMPLE 9

A recording medium of Example 9 was produced in the same manner as in Example 1, except that the coating solution 4 for undercoat layer was used in place of the coating solution 1b for undercoat layer in Example 1.

### COMPARATIVE EXAMPLE 3

A recording medium of Comparative Example 3 was produced in the same manner as in Example 1, except that the coating solution 5 for undercoat layer was used in place of the coating solution 1b for undercoat layer in Example 1.

### EXAMPLE 10

A recording medium of Example 10 was produced in the same manner as in Example 3, except that the coating solution B for ink-receiving layer was used in place of the coating solution A for ink-receiving layer in Example 3.

### EXAMPLE 11

A recording medium of Example 11 was produced in the same manner as in Example 3, except that the coating solution C for ink-receiving layer was used in place of the coating solution A for ink-receiving layer in Example 3.

### EXAMPLE 12

A recording medium of Example 12 was produced in the same manner as in Example 3, except that the coating solution D for ink-receiving layer was used in place of the coating solution A for ink-receiving layer in Example 3.

### COMPARATIVE EXAMPLE 4

A recording medium of Comparative Example 4 was produced in the same manner as in Example 3, except that the coating solution E for ink-receiving layer was used in place of the coating solution A for ink-receiving layer in Example 3.

### EXAMPLE 13

A recording medium of Example 13 was produced in the same manner as in Example 3, except that after coating and drying the undercoat layer, the undercoat layer was subjected to a hot calendering treatment (temperature: 100° C., nip pressure: 150 kg/cm).

### EXAMPLE 14

A recording medium of Example 14 was produced in the same manner as in Example 10, except that after coating and drying the undercoat layer, the undercoat layer was subjected to a hot calendering treatment (temperature: 100° C., nip pressure: 150 kg/cm) and pH of the coating solution B for ink-receiving layer was adjusted to 4.0 with hydrochloric acid.

### EXAMPLE 15

A recording medium of Example 15 was produced in the same manner as in Example 1, except that the coating solution 6a for undercoat layer was used in place of the coating solution 1b for undercoat layer in Example 1.

### EXAMPLE 16

A recording medium of Example 16 was produced in the same manner as in Example 1, except that the coating solution 6b for undercoat layer was used in place of the coating solution 1b for undercoat layer in Example 1.

### EXAMPLE 17

A recording medium of Example 17 was produced in the same manner as in Example 1, except that the coating solution 6c for undercoat layer was used in place of the coating solution 1b for undercoat layer in Example 1.

### EXAMPLE 18

A recording medium of Example 18 was produced in the same manner as in Example 1, except that the coating solution 7 for undercoat layer was used in place of the coating solution 1b for undercoat layer in Example 1.

### EXAMPLE 19

A recording medium of Example 19 was produced in the same manner as in Example 1, except that the coating solution 8 for undercoat layer was used in place of the coating solution 1b for undercoat layer in Example 1.

### EXAMPLE 20

A recording medium of Example 20 was produced in the same manner as in Example 1, except that the coating solution 11 for undercoat layer was used in place of the coating solution 1b for undercoat layer in Example 1.

### EXAMPLE 21

A recording medium of Example 21 was produced in the same manner as in Example 1, except that the coating solution 12 for undercoat layer was used in place of the coating solution 1b for undercoat layer in Example 1.

### EXAMPLE 22

A recording medium of Example 22 was produced in the same manner as in Example 1, except that the coating solution 13 for undercoat layer was used in place of the coating solution 1b for undercoat layer in Example 1.

### EXAMPLE 23

A recording medium of Example 23 was produced in the same manner as in Example 1, except that the coating solution 14 for undercoat layer was used in place of the coating solution 1b for undercoat layer in Example 1.

### EXAMPLE 24

A recording medium of Example 24 was produced in the same manner as in Example 1, except that the coating solution 15a for undercoat layer was used in place of the coating solution 1b for undercoat layer in Example 1.

### EXAMPLE 25

A recording medium of Example 25 was produced in the same manner as in Example 1, except that the coating solution 15b for undercoat layer was used in place of the coating solution 1b for undercoat layer in Example 1.

### EXAMPLE 26

A recording medium of Example 26 was produced in the same manner as in Example 1, except that the coating solution 15c for undercoat layer was used in place of the coating solution 1b for undercoat layer in Example 1.

### EXAMPLE 27

A recording medium of Example 27 was produced in the same manner as in Example 15, except that after coating and drying the undercoat layer, the undercoat layer was subjected to a hot calendering treatment (temperature: 100° C., nip pressure: 150 kg/cm).

### EXAMPLE 28

A recording medium of Example 28 was produced in the same manner as in Example 23, except that after coating and drying the undercoat layer, the undercoat layer was subjected to a hot calendering treatment (temperature: 100° C., nip pressure: 150 kg/cm).

### EXAMPLE 29

A recording medium of Example 29 was produced in the same manner as in Example 24, except that after coating and drying the undercoat layer, the undercoat layer was subjected to a hot calendering treatment (temperature: 100° C., nip pressure: 150 kg/cm).

### EXAMPLE 30

A recording medium of Example 30 was produced in the same manner as in Example 15, except that the coating solution B for ink-receiving layer was used in place of the coating solution A for ink-receiving layer in Example 15.

### EXAMPLE 31

A recording medium of Example 31 was produced in the same manner as in Example 15, except that the coating solution C for ink-receiving layer was used in place of the coating solution A for ink-receiving layer in Example 15.

### EXAMPLE 32

A recording medium of Example 32 was produced in the same manner as in Example 30, except that after coating and drying the undercoat layer, the undercoat layer was subjected to a hot calendering treatment (temperature: 100° C., nip pressure: 150 kg/cm).

### EXAMPLE 33

A recording medium of Example 33 was produced in the same manner as in Example 31, except that after coating and drying the undercoat layer, the undercoat layer is subjected to a hot calendering treatment (temperature: 100° C., nip pressure: 150 kg/cm).

### EXAMPLE 34

A recording medium of Example 34 was produced in the same manner as in Example 15, except that the coating solution 16a for undercoat layer was used in place of the coating solution 6a for undercoat layer in Example 15.

### EXAMPLE 35

A recording medium of Example 35 was produced in the same manner as in Example 15, except that the coating solution 16b for undercoat layer was used in place of the coating solution 6a for undercoat layer in Example 15.

### EXAMPLE 36

A recording medium of Example 36 was produced in the same manner as in Example 15, except that the coating solution 16c for undercoat layer was used in place of the coating solution 6a for undercoat layer in Example 15.

### EXAMPLE 37

A recording medium of Example 37 was produced in the same manner as in Example 15, except that the coating solution 16d for undercoat layer was used in place of the coating solution 6a for undercoat layer in Example 15.

### EXAMPLE 38

A recording medium of Example 38 was produced in the same manner as in Example 15, except that the coating solution 17 for undercoat layer was used in place of the coating solution 6a for undercoat layer in Example 15.

### EXAMPLE 39

A recording medium of Example 39 was produced in the same manner as in Example 15, except that the coating solution 18 for undercoat layer was used in place of the coating solution 6a for undercoat layer in Example 15.

### EXAMPLE 40

A recording medium of Example 40 was produced in the same manner as in Example 15, except that the coating solution D for ink-receiving layer was used in place of the coating solution A for ink-receiving layer in Example 15.

### COMPARATIVE EXAMPLE 5

A recording medium of Comparative Example 5 was produced in the same manner as in Example 15, except that the coating solution 9 for undercoat layer was used in place of the coating solution 6a for undercoat layer in Example 15.

### COMPARATIVE EXAMPLE 6

A recording medium of Comparative Example 6 was produced in the same manner as in Example 15, except that the coating solution 10 for undercoat layer was used in place of the coating solution 6a for undercoat layer in Example 15.

### COMPARATIVE EXAMPLE 7

A recording medium of Comparative Example 7 was produced in the same manner as in Example 15, except that the coating solution E for ink-receiving layer was used in place of the coating solution A for ink-receiving layer in Example 15.

Evaluation was conducted by the following evaluation methods. The results are shown in Tables 1-3.

<Evaluation of Ink Absorption>

A rectangular pattern of overlapped color was printed on the samples with a cyan ink, a magenta ink and a yellow ink using an ink jet recording apparatus PM9000 manufactured by Epson Co., Ltd. When amounts of the respective inks overlapped were all 100%, this was referred to as 300%, and when amounts of the respective inks were all 90%, this was referred to as 270%, and in this way, rectangular patterns of 240%, 210%, 180%, and 150% were prepared and printed. The state of overflowing of the ink at the boundary portion between the printed pattern and the unprinted part was visually evaluated and graded by the following criteria.

5: No overflowing was seen with 300% printing.

4: No overflowing was seen with 270% printing.

3: No overflowing was seen with 240% printing.

2: No overflowing was seen with 210% printing.

1: Overflowing was seen with 180% printing.

The grades 5-3 mean satisfactory ink absorption, and even in the case of the grade 2, there is no problem in practical use.

<Evaluation of Image Colorfulness>

Solid printing was carried out with a magenta ink and a cyan ink using Canon BJC-420J. Visual evaluation of the colorfulness of the printed image was conducted and the results were graded by the following criteria.

5: The color of the images was good and vivid.

4: The color of the images was good.

3: The color of the images was normal.

2: The color of the images was somewhat dull.

1: The color of the images was dim and considerably dull.

The grades 5-3 mean satisfactory image colorfulness, and even in the case of the grade 2, there is no problem in practical use.

<Evaluation of Gloss of Unprinted White Paper>

The state of gloss of the unprinted recording surface was visually evaluated.

5: The gloss feeling was very high.

4: The gloss feeling was high.

3: The gloss feeling was normal.

2: The gloss feeling was inferior.

1: The gloss feeling was very poor.

The grades 5-3 mean satisfactory gloss of white paper, and even in the case of the grade 2, there is no problem in practical use.

<Evaluation of Adhesion>

The coating on the recording surface of the recording medium was cut with a cutter knife at intervals of 5 mm crosswise, then an adhesive tape was applied to the cut surface and peeled, and the number of peeled squares of the ink-receiving layer per 100 squares was counted. The adhesion was evaluated in terms of the number of the peeled squares.

4: The number of the peeled squares was 0.

3: The number of the peeled squares was less than 10.

2: The number of the peeled squares was 10-30.

1: The number of the peeled squares was 31 or more.

The grades 3 and 4 mean satisfactory adhesion, and even in the case of 2, there is no problem in practical use.

<Measurement of Smoothness>

The smoothness of unprinted recording surface was measured using Beck tester in accordance with JIS-P-8119. The measurement unit was second, and the larger value means the higher smoothness.

TABLE 1

| | | Image | Gloss of | |
|---|---|---|---|---|
| Recording | Ink | colorful- | white | |
| medium | absorption | ness | paper | Adhesion |
| Comparative | 5 | 4 | 2 | 1 |
| Example 1 | | | | |
| Example 1 | 5 | 4 | 3 | 2 |
| Example 2 | 5 | 4 | 3 | 3 |
| Example 3 | 5 | 4 | 3 | 3 |
| Example 4 | 5 | 4 | 3 | 3 |
| Example 5 | 4 | 4 | 3 | 3 |
| Example 6 | 2 | 4 | 3 | 3 |
| Comparative | 1 | 4 | 3 | 3 |
| Example 2 | | | | |
| Example 7 | 4 | 4 | 3 | 3 |
| Example 8 | 5 | 4 | 3 | 3 |
| Example 9 | 3 | 4 | 2 | 3 |
| Comparative | 1 | 4 | 2 | 2 |
| Example 3 | | | | |
| Example 10 | 5 | 4 | 3 | 3 |
| Example 11 | 4 | 4 | 3 | 3 |
| Example 12 | 2 | 4 | 3 | 3 |
| Comparative | 4 | 1 | 1 | 3 |
| Example 4 | | | | |
| Example 13 | 5 | 4 | 4 | 3 |
| Example 14 | 5 | 4 | 4 | 3 |

TABLE 2

| | | | Gloss | | |
|---|---|---|---|---|---|
| | | | of | | |
| Recording | Ink | Image | white | | Smoothness |
| medium | absorption | colorfulness | paper | Adhesion | [sec] |
| Example 15 | 5 | 5 | 4 | 3 | 216 |
| Example 16 | 4 | 5 | 4 | 3 | 220 |
| Example 17 | 3 | 4 | 4 | 3 | 238 |
| Example 18 | 4 | 5 | 4 | 3 | 202 |
| Example 19 | 4 | 5 | 4 | 3 | 210 |
| Example 20 | 5 | 5 | 4 | 3 | 213 |
| Example 21 | 5 | 4 | 4 | 3 | 207 |
| Example 22 | 5 | 4 | 4 | 3 | 208 |
| Example 23 | 5 | 5 | 4 | 3 | 212 |
| Example 24 | 5 | 5 | 4 | 3 | 218 |
| Example 25 | 5 | 5 | 4 | 3 | 218 |
| Example 26 | 5 | 5 | 4 | 3 | 220 |
| Example 27 | 5 | 5 | 5 | 3 | 277 |
| Example 28 | 5 | 5 | 5 | 3 | 265 |
| Example 29 | 5 | 5 | 5 | 3 | 280 |

TABLE 3

| | | | Gloss | | |
|---|---|---|---|---|---|
| | | | of | | |
| Recording | Ink | Image | white | | Smoothness |
| medium | absorption | colorfulness | paper | Adhesion | [sec] |
| Example 30 | 4 | 5 | 4 | 3 | 206 |
| Example 31 | 4 | 5 | 4 | 3 | 202 |
| Example 32 | 4 | 5 | 5 | 3 | 253 |
| Example 33 | 4 | 5 | 5 | 3 | 256 |
| Example 34 | 5 | 4 | 4 | 2 | 204 |
| Example 35 | 5 | 5 | 4 | 3 | 208 |
| Example 36 | 4 | 4 | 4 | 4 | 221 |
| Example 37 | 3 | 3 | 4 | 4 | 228 |
| Example 38 | 3 | 3 | 4 | 3 | 213 |
| Example 39 | 3 | 3 | 5 | 3 | 215 |
| Example 40 | 3 | 4 | 4 | 3 | 214 |
| Comparative | 1 | 1 | 4 | 3 | 231 |
| Example 5 | | | | | |
| Comparative | 1 | 2 | 4 | 3 | 278 |
| Example 6 | | | | | |
| Comparative | 2 | 2 | 1 | 3 | 82 |
| Example 7 | | | | | |

From Table 1, the following can be seen. In Examples 1-14 where an ink-receiving layer containing inorganic ultrafine particles was provided on an undercoat layer containing a salt of an alkaline earth metal and an adhesive in an amount of 0.05-0.8 time the amount of the salt of the alkaline earth metal in weight ratio, there were obtained ink jet recording media which were excellent and well balanced in visual gloss of white paper, image colorfulness and ink absorption. On the other hand, when the undercoat layer did not contain the salt of alkaline earth metal (Comparative Example 3), the recording medium was inferior in gloss and absorption; even if the undercoat layer contained the salt of alkaline earth metal, when the weight ratio of the adhesive was less than 0.05 (Comparative Example 1), the adhesion was inferior and when the weight ratio of the adhesive was more than 0.8 (Comparative Example 2), the absorption was inferior, which was not preferred in practical use. Furthermore, when the pigment in the ink-receiving layer was not inorganic ultrafine particles (Comparative Example 4), the recording medium was inferior in gloss and colorfulness. The recording medium of Example 12 where pH of the coating solution for ink-receiving layer exceeded 5.0 was somewhat inferior in ink absorption to the recording media of Examples 3, 10 and 11 where the pH was not more than 5.0. When after coating the undercoat layer, this was subjected to hot calendering treatment (Examples 13 and 14), the recording media were further improved in visual gloss of white paper, and this was a preferred method.

From Tables 2 and 3, the following can be seen. In Examples 15-26, 30, 31 and 34-40 where an ink-receiving layer containing inorganic ultrafine particles was provided on an undercoat layer containing a salt of alkaline earth metal, an organic pigment and an adhesive, the resulting recording media were excellent and well balanced in gloss of white paper, image colorfulness, ink absorption, smoothness and adhesion. However, when the weight ratio of the adhesive to total solid content was less than 0.05 time (Example 34), the recording medium was excellent in ink absorption, but somewhat inferior in adhesion, and when it was more than 0.8 time (Example 37), the recording medium was excellent in adhesion, but somewhat inferior in ink absorption, and hence the weight ratio of 0.05-0.8 time was preferred. When the particle diameter of the organic pigment was less than 0.3 μm (Example 38), the recording medium was somewhat inferior in ink absorption and image colorfulness, and when it was more than 10 μm (Example 39), the recording medium was excellent in gloss of white paper, but somewhat inferior in ink absorption and image colorfulness, and therefore the particle diameter of the organic pigment was preferably 0.3-10 μm. When pH of the coating solution for the ink-receiving layer was higher than 5 (Example 40), ink absorption was somewhat inferior, and pH was preferably not higher than 5. However, when the undercoat layer contained a salt other than a salt of an alkaline earth metal (Comparative Example 5), ink absorption and image colorfulness were inferior, and even when the undercoat layer contained a salt of an alkaline earth metal, if it did not contain an organic pigment (Example 4), gloss of white paper was somewhat inferior, and on the other hand, when the undercoat layer contained only the organic pigment (Comparative Example 6), ink absorption was inferior. Furthermore, even when the undercoat layer contained a salt other than a salt of an alkaline earth metal and an organic pigment, if the pigment in the ink-receiving layer was not inorganic ultrafine particles (Comparative Example 7), gloss of white paper and smoothness were low and ink absorption and image colorfulness were inferior. Moreover, when after coating the undercoat layer, this was subjected to hot calendering treatment (Examples 27-29, 32 and 33), gloss of white paper and smoothness were further improved, and thus this was a preferred production method.

### INDUSTRIAL APPLICABILITY

As explained above, the present invention can provide ink jet recording media which were high in gloss, excellent in ink absorption and image colorfulness and free from problems in adhesion of the coats.

1. An ink jet recording medium which comprises a support, an undercoat layer provided on the support and an ink-receiving layer provided by coating a coating solution containing inorganic ultrafine particles on the undercoat layer, where the undercoat layer contains a salt of an alkaline earth metal and an adhesive.

2. An ink jet recording medium according to claim 1, wherein the undercoat layer contains the adhesive in an amount of 0.05-0.8 time the amount of the salt of the alkaline earth metal in weight ratio.

3. An ink jet recording medium according to claim 1 or 2, wherein the alkaline earth metal is calcium or magnesium.

4. An ink jet recording medium according to claim 1 or 2, wherein the salt of the alkaline earth metal is a carbonate.

5. An ink jet recording medium according to claim 1 or 2, wherein the inorganic ultrafine particles are of an amorphous synthetic silica produced by a gas phase method or an alumina compound.

6. An ink jet recording medium according to claim 1 or 2, wherein the coating solution for ink-receiving layer containing the inorganic ultrafine particles has a pH of not higher than 5.0.

7. An ink jet recording medium according to claim 1 or 2, wherein the undercoat layer contains the adhesive in an amount of 0.05-0.4 time the amount of the salt of the alkaline earth metal in weight ratio.

8. An ink jet recording medium according to claim 1, wherein the undercoat layer contains an organic pigment.

9. An ink jet recording medium according to claim 8, wherein the alkaline earth metal is calcium or magnesium.

10. An ink jet recording medium according to claim 8, wherein the salt of the alkaline earth metal is a carbonate.

11. An ink jet recording medium according to claim 8, wherein the undercoat layer contains the organic pigment in an amount of 0.05-20 times the amount of the salt of the alkaline earth metal in weight ratio.

12. An ink jet recording medium according to claim 8, wherein the organic pigment is a hollow organic pigment or a dense organic pigment.

13. An ink jet recording medium according to claim 8, wherein the organic pigment is a mixture of a hollow organic pigment and a dense organic pigment in an amount of 0.1-10 times the amount of the hollow organic pigment by weight ratio.

14. An ink jet recording medium according to claim 12, wherein the hollow organic pigment has an average void content of not less than 20%.

15. An ink jet recording medium according to claim 12, wherein the dense organic pigment is in the form of a bowl.

16. An ink jet recording medium according to claim 8, wherein the organic pigment has an average particle diameter of 0.3-10 μm.

17. An ink jet recording medium according to claim 8, wherein the inorganic ultrafine particles are of an amorphous synthetic silica produced by a gas phase method or an alumina compound.

18. An ink jet recording medium according to claim 8, wherein the coating solution for ink-receiving layer containing the inorganic ultrafine particles has a pH of not higher than 5.0.

19. An ink jet recording medium according to claim 8, wherein the undercoat layer contains the adhesive in an amount of 0.05-0.8 time the total solid content of the salt of the alkaline earth metal and the organic pigment in weight ratio.

20. A method for producing an ink jet recording medium which comprises providing an undercoat layer on a support and providing an ink-receiving layer thereon by coating a coating solution containing inorganic ultrafine particles on the undercoat layer, wherein the undercoat layer contains a salt of an alkaline earth metal and an adhesive in an amount of 0.05-0.8 time the amount of the salt of the alkaline earth metal in weight ratio, and after providing the undercoat layer, the undercoat layer is subjected to a hot calendering treatment and then the ink-receiving layer containing the inorganic ultrafine particles is provided.

21. A method for producing an ink jet recording medium according to claim 20, wherein the inorganic ultrafine particles are of an amorphous synthetic silica produced by a gas phase method or an alumina compound, and the coating solution for ink-receiving layer has a pH of not higher than 5.0.

22. A method for producing an ink jet recording medium which comprises providing an undercoat layer on a support and providing an ink-receiving layer thereon by coating a coating solution containing inorganic ultrafine particles on the undercoat layer, wherein the undercoat layer contains a salt of an alkaline earth metal, an organic pigment and an adhesive in an amount of 0.05-0.8 time the total solid content of the salt of the alkaline earth metal and the organic pigment in weight ratio, and after providing the undercoat layer, the undercoat layer is subjected to a hot calendering treatment and then the ink-receiving layer containing inorganic ultrafine particles is provided.

23. A method for producing an ink jet recording medium according to claim 22, wherein the inorganic ultrafine particles are of an amorphous synthetic silica produced by a gas phase method or an alumina compound, and the coating solution for ink-receiving layer has a pH of not higher than 5.0.
